(19) United States
(12) Patent Application Publication
(10) Pub. No.: US 2022/0244379 A1
(43) Pub. Date: Aug. 4, 2022

(54) METHOD AND DRIVER ASSISTANCE SYSTEM FOR CLASSIFYING OBJECTS IN THE SURROUNDINGS OF A VEHICLE

(71) Applicant: Robert Bosch GmbH, Stuttgart (DE)

(72) Inventors: Jianda Wang, Kanagawa (JP); Juergen Schmidt, Magstadt (DE); Lena Bendfeld, Stuttgart (DE); Michael Tchorzewski, Boeblingen (DE); Tom Reimann, Bissingen An Der Teck (DE); Werner Urban, Vaihingen/Enz (DE); Michael Schumann, Stuttgart (DE)

(21) Appl. No.: 17/612,427

(22) PCT Filed: Apr. 29, 2020
(86) PCT No.: PCT/EP2020/061910

§ 371 Date: Nov. 18, 2021

(30) Foreign Application Priority Data
May 26, 2019 (DE) 10 2019 207 688.2

(51) Int. Cl. G01S 15/931; G01B 17/02; B60W 40/06; B60W 50/14; B60W 40/04; G06N 20/20

(52) U.S. Cl. CPC G01S 15/931; G01B 17/02; B60W 40/06; B60W 50/14; B60W 40/04; B60W 30/09; B60W 2420/54; B60W 2554/20; B60W 2554/404; B60W 2552/00; B60W 2050/146; G06N 20/20

(57) ABSTRACT

A method for classifying objects in the surroundings of a vehicle using ultrasonic sensors which emit ultrasonic pulses and receive ultrasonic echoes reflected by objects. Distances between the sensors and objects reflecting ultrasonic pulses are ascertained via at least two ultrasonic sensors including overlapping fields of vision, and a position determination of the reflecting objects taking place using lateration and the assignment of the received ultrasonic echoes to object hypotheses for distinguishing between extensive objects and point-like objects. A height classification of a point-like object represented by an object hypothesis is carried out, based on an update rate of the object hypothesis, a stability of the position of the object represented by the object hypothesis, the amplitude of the ultrasonic echoes assigned to the object hypothesis, and a likelihood of the ultrasonic sensors receiving an ultrasonic echo from the object which is represented by the object hypothesis, as classification parameters.

### FIELD

The present invention relates to a method for classifying objects in the surroundings of a vehicle, using ultrasonic sensors which emit ultrasonic pulses and receive back ultrasonic echoes reflected by objects, distances between the respective ultrasonic sensor and objects in the surroundings reflecting ultrasonic pulses being ascertained via at least two ultrasonic sensors including at least partially overlapping fields of vision, and a position determination of the reflecting objects taking place with the aid of lateration and the assignment of the received ultrasonic echoes to object hypotheses for distinguishing between extensive objects and point-like objects. A further aspect of the present invention relates to a driver assistance system which is configured to carry out the method.

### BACKGROUND INFORMATION

Modern vehicles are equipped with a plurality of driver assistance systems which assist the driver of the vehicle by carrying out various driving maneuvers. Furthermore, some conventional driver assistance systems are available which warn the driver against hazards in the surroundings. For their function, the driver assistance systems require precise data about the surroundings of the vehicle and, in particular, about objects which are situated in the surroundings of the vehicle.

Frequently, ultrasound-based object localization methods are used, in which two or more ultrasonic sensors are used. In the process, the ultrasonic sensors each emit ultrasonic pulses and receive ultrasonic echoes reflected by objects in the surroundings. The distance between a reflecting object and the particular sensor may be ascertained in each case from the propagation time of the ultrasonic pulses until the reception of the corresponding ultrasonic echo as well as the known sound velocity. When an object is situated in the field of vision of more than one ultrasonic sensor, i.e., when the distance from the object may be ascertained by more than one ultrasonic sensor, it is also possible with the aid of lateration algorithms to ascertain the precise position of the reflecting object relative to the sensors or to the vehicle.

As a result of the ever larger fields of vision and sensitivities of the sensors, it is also increasingly possible to detect objects on the ground, such as curbs, speed bumps or manhole covers. It is important for the correct function of the driver assistance systems to be able to distinguish between collision-relevant objects, such as for example poles, walls or traffic signs, and traversable objects not relevant for a collision, such as for example curbs, speed bumps or manhole covers.

A method for detecting objects having a low height is described in German Patent Application No. DE 10 2009 046 158 A1. It is provided to continuously detect a distance from an object with the aid of distance sensors and to check whether the object continues to be detected by the distance sensors as the vehicle approaches and when a drop below a predefined distance occurs, or whether it disappears from the detection range of the distance sensors. If it is recognized that the object, during the approach, disappears from the detection range of the distance sensors, the object is classified as an object having a low height.

Moreover, there are methods in the related art which take advantage of the fact that high and extensive objects in general do not have a single, clearly defined reflection point, and thereby may cause multiple reflections, and thus multiple chronologically consecutive ultrasonic echoes, in response to a single ultrasonic pulse. In the case of a high object, for example, a reflection runs directly horizontally, i.e., in parallel to the ground from the sensor to the object and back. Another reflection is cast back by the space between the ground and the high object. This second ultrasonic echo arrives chronologically after the first ultrasonic echo since a longer path has to be covered from the installation position of the sensor to the transition between the object and the ground than the direct path extending in parallel to the ground. Furthermore certain objects, such as for example shrubs or pedestrians, but also flat objects, such as drainage grates or manhole covers, cause a plurality of reflections, which manifest themselves as a noise-like signal as an echo.

German Patent Application No. DE 10 2007 061 235 A1 describes a method for classifying the height of objects, utilizing statistical variance, which is, in particular, caused by multiple reflections of the measuring signal.

What is problematic about the conventional methods for height classification is that small objects and, as viewed in the plane, point-like objects, such as poles or traffic signs, hardly cause multiple reflections due to their low reflectivity, and that ultrasonic echoes reflected by these objects also only have a low amplitude, which therefore cannot be used as the sole criterion for a classification between low objects and high objects. A need therefore exists for a robust method for a height classification of the objects, in particular, in connection with such punctiform objects.

### SUMMARY

In accordance with an example embodiment of the present invention, a method is provided for classifying objects in the surroundings of a vehicle using ultrasonic sensors which emit ultrasonic pulses and receive back ultrasonic echoes reflected by objects. It is provided in the process to ascertain distances between the respective ultrasonic sensor and objects in the surroundings reflecting ultrasonic pulses via at least two ultrasonic sensors including at least partially overlapping fields of vision, and to carry out a position determination of the reflecting objects with the aid of lateration and the assignment of the received ultrasonic echoes to object hypotheses for distinguishing between extensive objects and point-like objects. It is furthermore provided to carry out a height classification of the point-like objects represented by an object hypothesis, the height classification taking place based on an update rate of the object hypothesis, a stability of the position of the object represented by the object hypothesis, the amplitude of the ultrasonic echoes assigned to the object hypothesis, and a likelihood of the ultrasonic sensors receiving an ultrasonic echo from the object which is represented by the object hypothesis, as classification parameters. A point-like object shall be understood to mean an object which, as viewed in a plane parallel to the ground, appears to be essentially point-like, i.e., only has a small expansion, such as for example in the case of a pole or a traffic sign. Furthermore, protruding parts of larger extensive objects are considered to be point-like objects, such as for example edges of houses, corners of vehicles, corners of curbs, corners of bumps or speed bumps, and the like. In this way, in particular, objects whose expansion visible to sensors is less than 10 cm are considered to be point-like objects. Conversely, an object which, as viewed in a plane in parallel to the ground, has extensive long edges, such as for example walls, brick walls or other vehicles, is considered to be an extensive object. In this way, in particular, objects which, as viewed in the plane parallel to the ground, have a visible edge including a length of 10 cm or more are considered to be extensive objects.

Within the scope of the example method of the present invention, ultrasonic pulses are continuously emitted, and ultrasonic echoes reflected by objects are accordingly continuously received back, using at least two ultrasonic sensors whose fields of vision at least partially overlap. Preferably, for this purpose, multiple ultrasonic sensors, for example two to five ultrasonic sensors, are situated as a group, for example at a bumper of a vehicle. Using the known sound velocity in air, the distances of the reflecting objects in the surroundings of the vehicle from the respective ultrasonic sensor are then determined. When an ultrasonic echo is received from multiple ultrasonic sensors, it may be assumed that the object reflecting ultrasonic pulses is situated in the overlapping field of vision of the two ultrasonic sensors. By using a lateration algorithm, the relative position of the reflecting object relative to the vehicle or relative to the ultrasonic sensors may be determined. For a determination of the position in the plane, as little as two ultrasonic sensors, which receive echoes from the object, are sufficient.

In accordance with an example embodiment of the present invention, in the method, it is provided to create object hypotheses. An object hypothesis combines all distances determined with the aid of the ultrasonic sensors and other measuring values, such as the registered amplitude of the ultrasonic echoes, which may be assigned to an object in the surroundings of the vehicle. Accordingly, each object hypothesis represents an object in the surroundings of the vehicle. In particular, chronologically consecutively obtained measuring values, i.e., distance values determined chronologically one after the other, may be assigned to one and the same object hypothesis when a lateration shows that the position of the respective object reflecting the ultrasound agrees with the position assigned to an object hypothesis or is situated in its vicinity. By evaluating the total number of measurements assigned to an object hypothesis, or distances and positions determined with the aid of the ultrasonic sensors, it is then possible to draw conclusions on the contour of the object. For example, when the vehicle is moving uniformly in one direction, and all positions assigned to an object hypothesis are situated on one line, or all positions of all ultrasonic sensors of a bumper which are assigned to an object hypothesis are situated on one line, it may be inferred that the object assigned to this object hypothesis is an extensive object, such as for example a brick wall or another vehicle. If, in contrast, the position approximately does not change, a point-like object is likely present, which, as viewed in the plane in parallel to the ground, only has a small geometric expansion. For example, it is a pole, a traffic sign or a characteristic corner of another object, such as for example a vehicle corner or a house corner or also a curb corner. Such a joining of individual measured distances from extensive objects is described, for example, in German Patent Application No. DE 10 2007 051 234 A1.

If an object hypothesis which is considered to be a point-like object is present, a height classification is carried out thereafter according to the described method. It is preferably provided in the process to distinguish between traversable objects and non-traversable objects. Such a distinction is significant since, for example, when a parking maneuver is carried out, a driving operation may be continued over a traversable object, while the driving maneuver has to be aborted or a warning has to be output when a non-traversable object is present.

According to an example embodiment of the present invention, it is provided to use a combination of different classification parameters for the classification of the height of the point-like objects. According to the present invention, the update rate of the object hypothesis, a stability of the position of the object represented by the object hypothesis, the amplitude of the ultrasonic echoes assigned to the object hypothesis, and a likelihood of the ultrasonic sensors receiving an echo from the object which is represented by the object hypothesis, are used as classification parameters.

The likelihood of an ultrasonic sensor receiving an ultrasonic echo for the object represented by the object hypothesis is preferably determined based on the position of the object relative to the field of vision of the particular ultrasonic sensor, an ascertained expansion of the object and/or a detection threshold of the ultrasonic sensor.

During the determination of the likelihood, the position of the object relative to the field of vision of the ultrasonic sensor has a great influence on the detection likelihood since the amplitude of the emitted ultrasonic signal, on the one hand, decreases with the distance and, on the other hand, steadily drops toward the edge of the field of vision or toward the edge of the sound lobe emitted by the ultrasonic sensor. For example, when the object is situated precisely in the center of the field of vision, the amplitude of the ultrasound impinging on the object is generally maximal, while the amplitude continues to drop the further the object moves away from the center of the field of vision. Furthermore, the expansion of the object has great influence on how large the amplitude of the reflected ultrasonic echo is. A large, extensive object will reflect more sound energy than a small object. Furthermore, a detection threshold is generally provided with ultrasonic sensors to not classify conventional noise as well as ultrasonic echoes caused by the ground or the ground surface as ultrasonic echoes of an object. An ultrasonic echo will only be classified as an ultrasonic echo reflected by an object when its amplitude is above the predefined threshold.

It is preferably provided in the process to adapt the detection threshold in each case to the instantaneously present ambient conditions so that the detection threshold is lowered in the case of low ambient noise or a low number of ground echoes, and conversely, to raise the detection threshold in loud surroundings including a lot of interference signals and high noise and/or a high number of ground echoes, for example due to a rough ground surface such as gravel. For the adaptation of the detection threshold, an algorithm may be used, for example, which regulates the detection threshold in such a way that a constant false alarm rate (CAFR) is achieved.

As another criterion, it is preferably provided to use the amplitude of the ultrasonic echo assigned to the object hypothesis for the height classification. On the one hand, it is possible in the process to take advantage of the fact that large, extensive objects generally have a higher amplitude than smaller objects. On the other hand, as is described, for example, in German Patent Application No. DE 10 2009 046 158 A1, when the object approaches the vehicle or the object approaches the ultrasonic sensors, the change in the amplitude may be monitored as to whether the object continues to be detected or disappears from the field of vision of the ultrasonic sensors. Such a “diving” of the object beneath the field of vision of an ultrasonic sensor is an indicator that it is a low object. The analysis of the amplitude as the object approaches the ultrasonic sensor may, in particular, also include a standardization of the amplitudes, taking into consideration an expansion of the object represented by the object hypothesis and/or the likelihood of the detection.

The stability of the position of the object represented by the object hypothesis is preferably taken into consideration as a criterion for the classification of the height of a point-like object. This takes advantage of the fact that high point-like objects, such as poles and traffic signs, have a well-defined reflection point, which is always reliably detected, regardless of the relative position between the object and the vehicle. In the case of low objects, such as for example a corner of a curb, which appear as point-like objects, there is no well-defined reflection point for the impinging ultrasound, so that the determined position of the point-like object seemingly migrates when the object approaches the vehicle or the particular ultrasonic sensor. Furthermore, this apparent migration may cause a distinction between extensive objects and point-like objects to be made more difficult by this apparent migration of the position. This may be taken into consideration by assigning a confidence value to a classification as a point-like object or an extensive object, this confidence value preferably being taken into consideration as a classification parameter for the height classification. In the process, a greater uncertainty during the classification is indicative of a low object, and low uncertainties or a high confidence value is indicative of a high point-like object.

Preferably, the update rate of the object hypothesis is used as a classification parameter for the height classification. This takes advantage of the fact that the likelihood that the object is simultaneously detected by more than one of the ultrasonic sensors is higher or lower, depending on the condition of the object. In the case of extensive objects, it is generally ensured that the object is simultaneously situated in the field of vision of more than one ultrasonic sensor, and a lateration may thus be frequently carried out. This makes it possible to frequently determine the position of the object reflecting the ultrasound, and thus to assign the measured distance values to an object hypothesis and to thereby update it. In the case of small point-like objects, in contrast, the likelihood that the object is simultaneously detected by more than one ultrasonic sensor, i.e., that an ultrasonic echo reflected by this point-like object is picked up by at least two ultrasonic sensors, is accordingly lower. In this way, a corresponding object hypothesis has to be updated less frequently for a point-like object. If the point-like object is a high object, a direct sound reflection is generally possible so that the likelihood that at least two ultrasonic sensors simultaneously pick up an echo of this high point-like object is greater than in the case of a low point-like object. A low update rate of an object hypothesis is thus indicative of a low point-like object.

An update of an object hypothesis preferably takes place whenever a further ultrasonic echo is added to this object hypothesis. This generally occurs whenever a successful lateration may be carried out, i.e., the ultrasonic echo of the object represented by the object hypothesis is received by at least two ultrasonic sensors, for which then, with the aid of lateration, the position may be ascertained and assigned to an object hypothesis.

The height classification of the point-like objects, using the described classification parameters, may, in particular, be carried out using a statistical evaluation method or a machine learning method. In the process, in particular, weighting factors and links between the classification parameters are created, based on a training data set. Such a training data set, in addition to the classification as a point-like high object or a point-like low object, includes the associated measuring values for the classification parameters for a situation in which a known object is present. A suitable machine learning method is the so-called random forest method, in which a plurality of decision trees is created, using the training data set. During the subsequent use with unknown data, the results of all decision trees are taken into consideration, and the most likely result is selected.

Another aspect of the present invention relates to a driver assistance system, including at least two ultrasonic sensors including at least partially overlapping fields of vision and a control unit. The driver assistance system is designed and/or configured to carry out one of the methods described herein in accordance with the present invention.

Since the driver assistance system is designed and/or configured to carry out one of the methods, features described within the scope of one of the methods apply correspondingly to the driver assistance system, and conversely, features described within the scope of one of the driver assistance systems apply vice versa to the methods.

The driver assistance system is accordingly configured to recognize objects in the surroundings of a vehicle, using the at least two ultrasonic sensors, and to carry out a classification into extensive and point-like objects and, when a point-like object is present, to subject it to a height classification.

The driver assistance system is preferably configured to provide various assistance functions, using the ascertained data about objects in the surroundings of the vehicle. The driver assistance system preferably includes a display function and a safety function. In the case of the display function, a distance from a collision-relevant object in the surroundings of the vehicle is displayed, for example on a display, acoustically or with the aid of indicator lamps. The safety function is preferably provided so that an intervention in a driving function is carried out when a hazardous situation is present. Such an intervention in a driving function may be, for example, carrying out a brake intervention or a steering intervention. A hazardous situation is, in particular, present when it is detected that a collision with a non-traversable object is imminent.

In one preferred specific embodiment of the described driver assistance system in accordance with the present invention, it is provided to use different weightings of the classification parameters in each case for the display function and the safety function when carrying out the height classification of the point-like objects. It is preferred in the process to predefine the weightings of the classification parameters in such a way that the likelihood of a classification as a non-traversable object is greater for the display function than for the safety function.

Furthermore, a vehicle is described, which includes one of the driver assistance systems described herein.

The example method provided according to the present invention enables the height classification for objects which appear to be point-like to distance sensors. A reliable height classification and, in particular, a reliable classification into traversable objects and non-traversable objects is crucial for a reliable function of many driver assistance systems. The driver assistance systems should not trigger any warning or even a brake intervention in the case of flat, traversable objects, such as for example curbs, speed bumps or manhole covers, while collision-relevant objects, such as poles, walls, traffic signs or edges of other objects, such as house corners or vehicle corners, have to be reliably recognized.

The provided method may advantageously be used with all existing systems which include ultrasonic sensors including at least partially overlapping fields of vision and which are able to carry out a lateration. Additional sensors are not required.

As a result of a classification of point-like objects into high objects, which are relevant for collisions, and low objects, which are traversable and do not necessitate a response of a driver assistance system, in particular, the number of incorrect warnings or even the number of incorrect system reactions, even though no collision-relevant object is present, is reduced, so that the acceptance of the driver assistance systems by the driver is increased.

Furthermore, it is possible, depending on the application, to differently select the weighting of the individual classification parameters used for the height classification. For example, in the case of driver assistance systems which only have a display function, a higher rate with which a low object, which is traversable, is erroneously classified as a high object, i.e., a non-traversable object, may be accepted than in the case of driver assistance systems which have a safety function and, for example, are able to carry out a brake intervention.

### BRIEF DESCRIPTION OF THE DRAWINGS

Exemplary embodiments of the present invention are described in greater detail based on the figures and the following description.

FIG. 1 shows a vehicle including a driver assistance system according to an example embodiment of the present invention in a view from the side.

FIG. 2 shows fields of vision of multiple ultrasonic sensors at the installation height of the sensors in a view from above.

FIG. 3 shows the fields of vision of the ultrasonic sensors at ground height in a view from above.

### DETAILED DESCRIPTION OF EXAMPLE EMBODIMENTS

In the following description of the specific example embodiments of the present invention, identical or similar elements are denoted by the same reference numerals, a repeated description of these elements in individual cases being dispensed with. The figures only schematically represent the subject matter of the present invention.

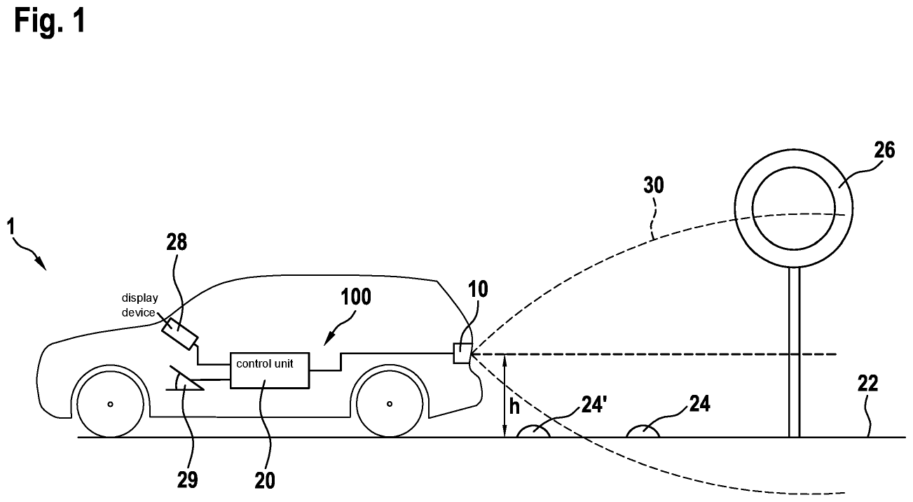

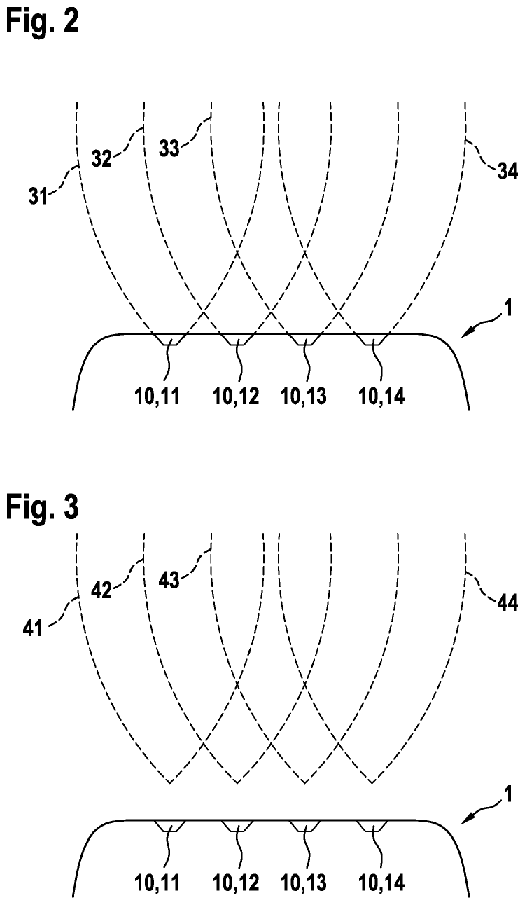

FIG. 1 shows a vehicle 1 which is situated on a street 22 in a view from the side. Vehicle 1 includes a driver assistance system 100 including an ultrasonic sensor 10 and a control unit 20. Only one ultrasonic sensor 10 is visible in the side view of FIG. 1; however, vehicle 1 includes multiple ultrasonic sensors 10; cf. FIGS. 2 and 3. In the specific embodiment shown in FIG. 1, driver assistance system 100 additionally includes a display device 28 connected to control unit 20. Control unit 20 is furthermore configured to carry out a brake intervention. This is shown in the representation of FIG. 1 by a connection of control unit 20 to a pedal 29.

Ultrasonic sensor 10 visible in FIG. 1 is mounted at vehicle 1 at an installation height h at the rear of vehicle 1. Ultrasonic sensor 10 has a field of vision 30 within which ultrasonic sensor 10 is able to recognize objects such as traffic sign 26 or a speed bump 24. The further speed bump 24′ also shown in FIG. 1, which compared to speed bump 24 is situated closer to vehicle 1, may no longer be recognized by ultrasonic sensor 10 in the situation shown in FIG. 1 since this further speed bump 24′ is situated outside field of vision 30 of ultrasonic sensor 10. A height classification of speed bump 24 may be recognized by a change in the amplitude or a change in the detection behavior when vehicle 1 approaches speed bump 24. If vehicle 1 backs up slowly in the direction of speed bump 24, the speed bump, at a certain point, will leave field of vision 30 of ultrasonic sensor 10, which becomes apparent from a drastic drop in an amplitude of a corresponding ultrasonic echo. The point in time or the distance of speed bump 24 from vehicle 1 at the point in time at which it is no longer recognizable by ultrasonic sensor 10 may then be used to draw conclusions on the height of speed bump 24. If speed bump 24 were a high object, similarly to traffic sign 26, it is not possible to leave field of vision 30 of ultrasonic sensor 10 when approached. It is only possible for field of vision 30 to be left during an approach in the case of low, generally traversable objects.

A reliable classification of traffic sign 26 as a high object, however, is not possible solely based on the amplitude due to the comparatively small area which is able to reflect ultrasound of ultrasonic sensor 10, and thus due to the comparatively small amplitudes of the received ultrasonic echoes. Additional criteria thus have to be used. According to the present invention, an update rate of an object hypothesis representing the object, the amplitude of the ultrasonic echo, the stability of the position determination of the object, and the likelihood of ultrasonic sensors 10 receiving an ultrasonic echo from the object, are used as classification parameters.

When a collision-relevant, i.e., a high, non-traversable object is recognized, a warning may be output via display device 28 and/or a brake intervention may take place.

FIG. 2 schematically shows the rear of vehicle 1 at which four ultrasonic sensors 10 are mounted in the example shown in FIG. 2. FIG. 2 schematically shows the fields of vision assigned to ultrasonic sensors 11 through 14 at installation height 31 through 34 of ultrasonic sensors 10; cf. FIG. 1.

FIG. 3 shows the same arrangement of ultrasonic sensors 10 of vehicle 1. In contrast to FIG. 2, the fields of vision are plotted at ground height 41 through 44.

It becomes apparent from comparison between FIGS. 2 and 3 that the fields of vision at installation height 31 through 34 are larger than the corresponding fields of vision at ground height 41 through 44 and that, in particular, areas in which fields of vision 31 through 34, 41 through 44 of at least two ultrasonic sensors 10 overlap are considerably larger, when viewed at installation height h, than at ground height.

It becomes apparent from the comparison of the fields of vision at installation height 31 through 34 of FIG. 2 to the fields of vision at ground height 41 through 44 that, in the case of an object which has a low height above the ground, there is a lower likelihood that it is simultaneously situated in field of vision 30 of at least two ultrasonic sensors 10 than for an object in the same position which has a height which at least corresponds to installation height h of ultrasonic sensors 10; cf. FIG. 1.

A lateration, and thus a position determination of an object reflecting an ultrasound, is only possible when at least two ultrasonic sensors 10 receive ultrasonic echoes reflected by this object. Object hypotheses which represent actual objects in the surroundings of vehicle 1 may only be created and/or updated when the position of the object reflecting the ultrasound is known. From this follows accordingly that, when measurements are continuously carried out using ultrasonic sensors 10, the likelihood that a high object is recognized is greater than a low object. Once an object has been recognized and, correspondingly, an object hypothesis has been created, it is correspondingly updated with a higher likelihood when it is a high object than when it is a low object. In this way, an update rate of an object hypothesis may be used as a criterion for carrying out a height classification.

Furthermore, it may be derived from the shown representation of the fields of vision at ground height 41 through 44 of FIG. 3 and the representation of the fields of vision at installation height 31 through 34 that the relative position of an object relative to fields of vision 31 through 34 and 41 through 44 also has an influence on the detection likelihood. Since the sound amplitude, proceeding from the center of fields of vision 31 through 34 and 41 through 44, steadily decreases toward the edges, the likelihood of being able to detect an object is greater when it is situated in the center of one or multiple field(s) of vision 31 through 34 and 41 through 44 than when the same object is situated at the edge of fields of vision 31 through 34 and 41 through 44. Accordingly, it is preferred to take the detection likelihood which is given by the relative position of the object at fields of vision 31 through 34 and 41 through 44 into consideration during the classification.

The present invention is not limited to the exemplary embodiments described here and the aspects highlighted therein. Rather, a plurality of modifications is possible within the scope of the present invention, which are within the capabilities of those skilled in the art in view of the disclosure herein.

1-10. (canceled)

11. A method for classifying objects in surroundings of a vehicle using ultrasonic sensors which emit ultrasonic pulses and receive back ultrasonic echoes reflected by objects, the method comprising:
ascertaining, using at least two ultrasonic sensors having at least partially overlapping fields of vision, distances between each respective ultrasonic sensor of the at least two sensors and objects in the surroundings reflecting ultrasonic pulses;
determining a position of the reflecting objects using lateration;
assigning received ultrasonic echoes to object hypotheses for distinguishing between extensive objects and point-like objects; and
carrying out a height classification of a point-like object represented by an object hypothesis of the object hypotheses, based on an update rate of the object hypothesis, a stability of the position of the object represented by the object hypothesis, an amplitude of the ultrasonic echoes assigned to the object hypothesis, and a likelihood of the at least two ultrasonic sensors receiving an ultrasonic echo from the object represented by the object hypothesis, as classification parameters.

12. The method as recited in claim 11, wherein the likelihood of each ultrasonic sensor receiving an ultrasonic echo for the object represented by the object hypothesis is determined based on the position of the object relative to the field of vision of the ultrasonic sensor, and/or an ascertained expansion of the object and/or a respective detection threshold of the ultrasonic sensor.

13. The method as recited in claim 12, wherein the respective detection threshold of each of the at least two ultrasonic sensors is adapted to an instantaneous noise level in such a way that a rate for an incorrect classification of an ultrasonic echo as the echo of an object is constant.

14. The method as recited in claim 11, wherein a correction of the amplitude of an ultrasonic echo takes place as a function of an ascertained expansion of the object represented by the object hypothesis.

15. The method as recited in claim 11, wherein a confidence value for the classification as a point-like object is taken into consideration as a further classification parameter for the height classification.

16. The method as recited in claim 11, wherein an update of each object hypothesis takes place when a further ultrasonic echo is added to the object hypothesis.

17. The method as recited in claim 11, wherein the height classification takes place using a statistical evaluation method or a machine learning method.

18. The method as recited in claim 17, wherein the height classification takes place using the machine learning method, a random forest method being used as the machine learning method.

19. A driver assistance system, comprising:
at least two ultrasonic sensors having overlapping fields of vision;
a control unit;
wherein the driver assistance system is configured to classify objects in surroundings of a vehicle using the ultrasonic sensors, the ultrasonic sensors being configured to emit ultrasonic pulses and receive back ultrasonic echoes reflected by objects, the driver assistance system configured to:
ascertain, using the at least two ultrasonic sensors, distances between each respective ultrasonic sensor of the sensors and objects in the surroundings reflecting ultrasonic pulses;
determine a position of the reflecting objects using lateration;
assign received ultrasonic echoes to object hypotheses for distinguishing between extensive objects and point-like objects; and
carry out a height classification of a point-like object represented by an object hypothesis of the object hypotheses, based on an update rate of the object hypothesis, a stability of the position of the object represented by the object hypothesis, an amplitude of the ultrasonic echoes assigned to the object hypothesis, and a likelihood of the ultrasonic sensors receiving an ultrasonic echo from the object represented by the object hypothesis, as classification parameters.

20. The driver assistance system as recited in claim 19, wherein the driver assistance system includes a display function and a safety function, the display function representing information about the objects in the surroundings of the vehicle on a display device, and the safety function being configured to carry out an intervention in a driving function when a hazardous situation is present, wherein different weightings of the classification parameters are in each case provided for the display function and the safety function.
